(19) United States
(12) Patent Application Publication
(10) Pub. No.: US 2007/0082516 A1
(43) Pub. Date: Apr. 12, 2007

(54) Electric contactor

(76) Inventors: Ted Ju, Keelung City (TW); Wen-Chang Chang, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/266,264

(22) Filed: Nov. 4, 2005

(30) Foreign Application Priority Data
Oct. 7, 2005 (TW) 94217450

(51) Int. Cl. H01R 12/00

(52) U.S. Cl. 439/74

(57) ABSTRACT

An electric contactor includes an insulating main body and a plurality of conducting terminals. Several terminal accommodating holes are formed on the insulating main body. Each accommodating hole has a first conducting terminal and a second conducting terminal connected together, and the first and second conducting terminals can move relative to each other. The first and second conducting terminals are made of different materials. The first conducting terminal is made of material with a higher conductivity, while the second conducting terminal is made of material with a larger tensile strength. The conducting terminals have a high conductivity, a simple structure, can effectively reduce the inductive effect, and can be densely arranged, thereby meeting the requirement of high-frequency circuits and realizing high transmission of electronic component and circuit board.

### BACKGROUND OF THE INVENTION

1. Field of the Invention

The present invention relates to an electric contactor and, more particularly, to an electric contactor used to obtain a contact pressure with a chip module.

2. Description of Related Art

Today, land grid array (LGA) chip modules are used in some electronic products (e.g., computers). The conducting end of the LGA chip module is of a gasket shape. An electric contactor connected with the LGA chip module has a terminal for obtaining a contact pressure with the conducting end. As shown in FIGS. 6 and 7, a conventional electric contactor has a terminal 100 that is integrally formed. Although the electric contactor has a high conductivity, the terminal 100 will incline toward one side to easily generate a displacement when a chip module is installed. Moreover, the terminal 100 has a complicated shape and occupies a large space, and thus cannot be densely arranged. Besides, the terminal 100 can easily generate a high inductive effect with adjacent terminals to be detrimental to transmission of high-frequency signals. Because of the above reasons, an electric contactor making use of two terminals connected together to achieve electric connection has been proposed recently, as disclosed in U.S. Pat. No. 5,362,241. The electric contactor uses a fixed terminal and a movable terminal to obtain a contact pressure with a chip or a circuit board. Although this kind of electric contactor has a simplified terminal structure to reduce the inductive effect, and the terminals thereof can be densely arranged to more meet the requirements for high-frequency circuits, the two terminals thereof are commonly made of alloyed copper that is either expensive or has a low conductivity. For instance, phosphorized copper has a low price, but its conductivity is only slightly larger than 20% IACS; particular copper alloy has a moderate price, but its conductivity is about 40% to 60% IACS; beryllium copper has a conductivity about higher than 80% IACS, but it is very expensive. Moreover, because the electric contactor is composed of two terminals instead of a single terminal, there exists an extra terminal resistance to cause a not high enough total conductivity, hence being detrimental to the transmission of high-frequency signals.

Accordingly, the present invention aims to propose a novel electric contactor to solve the above problems in the prior art.

### SUMMARY OF THE INVENTION

An object of the present invention is to provide a novel electric contactor, which has conducting terminals with a high conductivity and has a simple structure to accomplish high transmission with electronic components and circuit boards.

To achieve the above object, the present invention provides an electric contactor comprising an insulating main body and a plurality of conducting terminals. Several terminal accommodating holes are formed on the insulating main body. Each accommodating hole has a first conducting terminal and a second conducting terminal connected together, and the first and second conducting terminals can move relative to each other. The first and second conducting terminals are made of different materials. The first conducting terminal is made of material with a higher conductivity, while the second conducting terminal is made of material with a larger tensile strength.

As compared to the prior art, the conducting terminals of the electric contactor of the present invention has a high conductivity, and a simple structure to effectively reduce the inductive effect, and can be densely arranged to meet the requirements for high-frequency circuits, thereby accomplishing high transmission with electronic components and circuit boards.

### BRIEF DESCRIPTION OF THE DRAWINGS

The various objects and advantages of the present invention will be more readily understood from the following detailed description when read in conjunction with the appended drawing, in which:

FIG. 1 is a perspective view of an electric contactor of the present invention;

FIG. 2 is a perspective view of a first conducting terminal of an electric contactor of the present invention;

FIG. 3 is a perspective view of a second conducting terminal of an electric contactor of the present invention;

FIG. 4 is a diagram of an electric contactor of the present invention with a chip module installed;

FIG. 5 is a diagram of an electric contactor of the prevent invention;

FIG. 6 is a perspective view of a conventional terminal; and

FIG. 7 is a partly cross-sectional view of a conventional terminal.

### DETAILED DESCRIPTION OF THE PREFERRED EMBODIMENTS

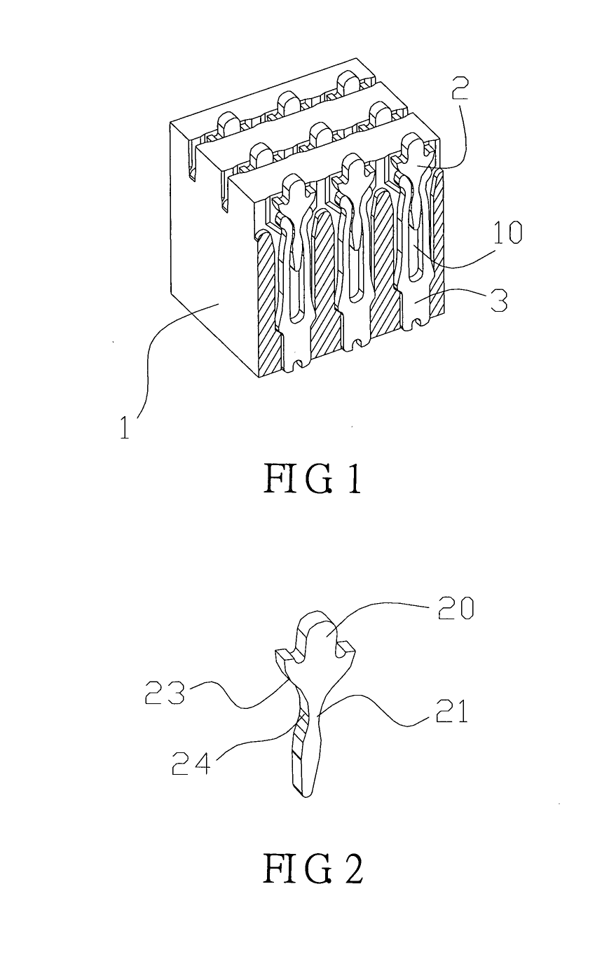

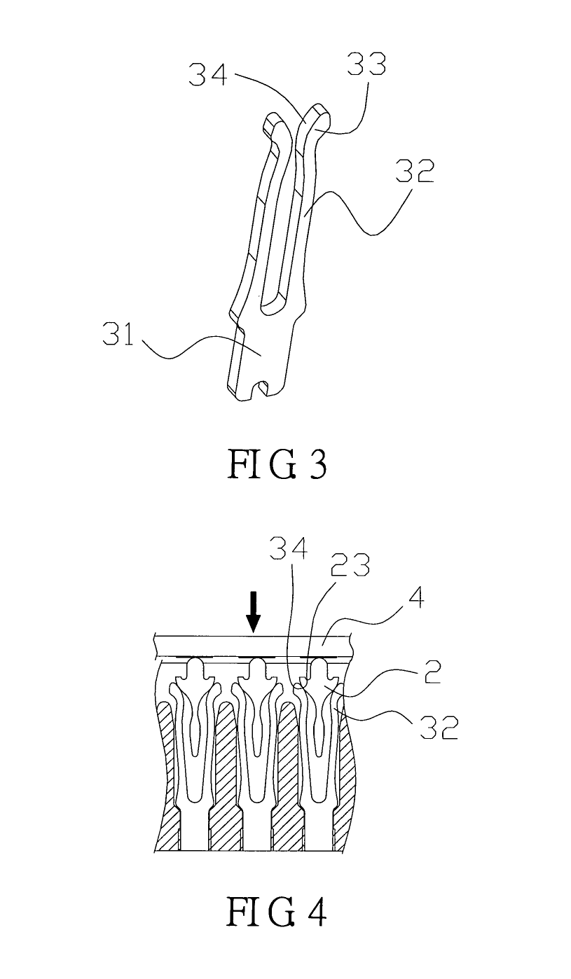

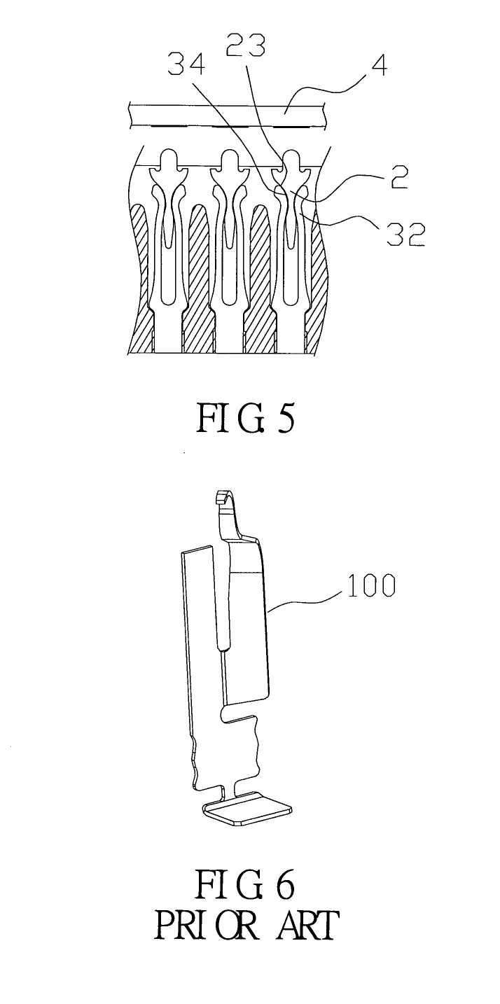

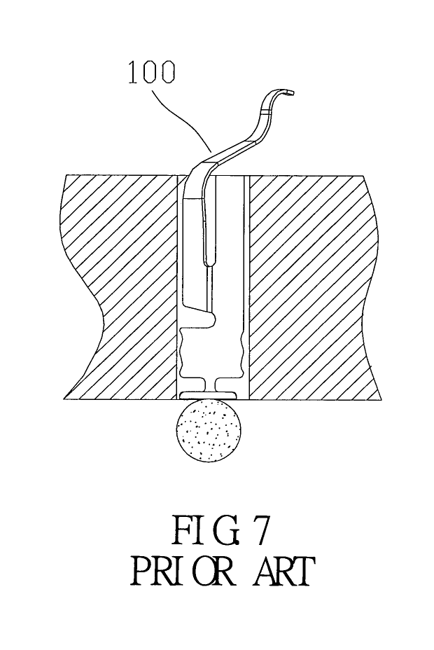

As shown in FIGS. 1 to 3, an electric contactor of the present invention includes an insulating body 1 and a plurality of conducting terminals. Several terminal accommodating holes 10 are formed on the insulating main body 1. Each accommodating hole 10 has a first conducting terminal 2 and a second conducting terminal 3 connected together, and the first conducting terminal 2 and the second conducting terminal 3 can move relative to each other. The first conducting terminal 2 and the second conducting terminal 3 are made of different materials, but they are made of metal of the same sheet shape. The thickness of the first conducting terminal 2 is larger than that of the second conducting terminal 3.

The first conducting terminal 2 is made of pure copper, containing more than 95% of copper, and thus has a very high conductivity, generally larger than 70% IACS, but its tensile strength is smaller, generally smaller than 500 N/mm². One end of the first conducting terminal 2 forms a first conducting portion 20 capable of electrically connecting an external electronic component (a chip module 4 is this embodiment, but another electronic component is also feasible), the other end thereof forms a pressure bearing portion 21. The pressure bearing portion 21 has two first inclined planes 23 facing downwardly. Grooves 24 are also disposed on the pressure bearing portion 21. The second conducting terminal 2 is made of alloyed copper, which has a larger tensile strength, generally larger than 500 N/mm², but has a low conductivity, generally lower than 70% IACS. One end of the conducting terminal 3 forms a second conducting portion 31 capable of electrically connecting an external electronic component (a circuit board in this embodiment, but another electronic component is also feasible), the other end thereof forms two resilient portions 32 capable of elastically abutting against the pressure bearing portion 21. Two abutting portions 33 extend upwardly from the two resilient portions 32. The distal ends of the resilient portions 32 also have two second inclined planes 34 facing upwardly. The first inclined planes 23 can abut against the second inclined planes 34, and the abutting portions 33 can be engaged with the grooves 24, thereby achieving firm connection by means of engagement of concave/convex patterns.

As shown in FIGS. 4 and 5, when a chip module 4 is installed, the first conducting terminal 2 is exerted by a force to move downwardly. Relative motion of the inclined planes 23 and 34 of the first and second conducting terminals 2 and 3 will shift the resilient portions 32. When the force is released, the resilient portions 32 will restore to their original shapes to spring back the first conducting terminal 2 upwards. An electric contactor capable of obtaining contact pressure is thus formed.

As compared to the prior art, the conducting terminals of the electric contactor of the present invention has a high conductivity, and a simple structure to effectively reduce the inductive effect, and can be densely arranged to meet the requirements for high-frequency circuits, thereby accomplishing high transmission with electronic components and circuit boards.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. An electric contactor comprising:
an insulating main body having formed thereon a plurality of terminal accommodating holes; and
a substantially planar first conducting terminal and a substantially planar second conducting terminal received in each of said accommodating holes, said first conducting terminal having a pressure bearing portion interstitially received in a pair of resilient portions formed on said second conducting terminal, said first conducting terminal being displaceable in a plane defined by said second conducting terminal against a biasing force applied by said resilient portions, said first and second conducting terminals being formed from different conductive materials, said first conducting terminal being formed of a material having a conductivity greater than 70% of the International Annealed Copper Standard (IACS) and the second conducting terminal being formed of a material having a tensile strength greater than 500 N/mm².

2. The electric contactor as claimed in claim 1, wherein the material of said first conducting terminal has a tensile strength smaller than that of said second conducting terminal.

3. The electric contactor as claimed in claim 2, wherein the material of said first conducting terminal has a tensile strength smaller than 500 N/mm².

4. The electric contactor as claimed in claim 1, wherein the material of said second conducting terminal has a conductivity lower than that of said first conducting terminal.

5. The electric contactor as claimed in claim 4, wherein the material of said second conducting terminal has a conductivity lower than 70% IACS.

6-7. (canceled)

8. The electric contactor as claimed in claim 1, wherein the material of said first conducting terminal has a conductivity greater than 90% IACS.

9. The electric contactor as claimed in claim 1, wherein the material of said first conducting terminal is of more than 95% copper.

10. The electric contactor as claimed in claim 1, wherein one end of said first conducting terminal forms a first conducting portion for electrically connecting an external electronic component, and the other end thereof forms said pressure bearing portion, one end of said second conducting terminal forms a second conducting portion for electrically connecting another external electronic component, and the other end thereof forms said resilient portions elastically abutting against said pressure bearing portion.

11. The electric contactor as claimed in claim 10, wherein said first and second conducting terminals engaged to each other firmly by means of engagement of concave/convex patterns.

12. The electric contactor as claimed in claim 10, wherein said pressure bearing portion and said resilient portions have respectively formed on edges thereof inclined planes abutting against each other, wherein said biasing force on said first conducting terminal is applied by a longitudinal force of said inclined planes of said first conducting terminal on said inclined planes of said second conducting terminal so as to spread said resilient portions.

13. The electric contactor as claimed in claim 1, wherein said pressure bearing portion of said first conducting terminal has a plurality of spaced grooves formed thereon for respective engagement with abutting portions of said pair of resilient portions of said second conducting terminal.
